(19) United States
(12) Patent Application Publication
(10) Pub. No.: US 2026/0359960 A1
(43) Pub. Date: Nov. 12, 2026

(54) METHOD FOR QUANTIFYING LANE DISCOLORATION

(71) Applicant: GM GLOBAL TECHNOLOGY OPERATIONS LLC, Detroit, MI (US)

(72) Inventors: Alexander Escatel, Clinton Township, MI (US); Alaa Awni Al-Naber, Sterling Heights, MI (US); James Scott MacGuidwin, Northville, MI (US); Patrick Cooke, Bloomfield Hills, MI (US)

(73) Assignee: GM GLOBAL TECHNOLOGY OPERATIONS LLC, Detroit, MI (US)

(21) Appl. No.: 19/201,243

(22) Filed: May 7, 2025

(51) Int. Cl. G06T 7/00; G01C 11/04; G01N 21/27; G06T 7/11; G06T 7/90; G06T 11/10; G06V 20/56; G07C 5/02

(52) U.S. Cl. CPC G06T 7/0002; G01C 11/04; G01N 21/27; G06T 7/11; G06T 7/90; G06T 11/10; G06V 20/588; G06T 2207/10024; G06T 2207/20132; G06T 2207/30168; G06T 2207/30256; G07C 5/02

(57) ABSTRACT

A method and system for determining a paint quality level for a lane marking of a road surface as a vehicle is traveling along a road is provided. A sensed data stream indicative of the road surface of the road is received and the road surface for an eligibility requirement to determine a paint quality level of the lane marking associated with the road surface. An image of the road surface along the road traveled by the vehicle is captured based on whether the road surface is eligible to determine the paint quality level. An object detection model is employed to detect whether the lane marking exists on the road surface within the image captured. The paint quality level for the detected lane marking is determined based on a paint quality degradation model and a paint color.

### INTRODUCTION

The technical field generally relates to determining a paint quality level for a lane marking associated with a vehicle, and more particularity relates to a method and system for determining a paint quality level of a lane marking of a road surface using a vehicle system while the vehicle is traveling along the road surface of a road.

In various locations around the world, cities and states utilize paint lane marking on roadways to convey and direct drivers through traffic flows. In some forms, semi-autonomous and fully autonomous vehicles may also utilize the lane markings as part of the driving system to navigate the terrain of the roadways. The paint used to create the lane markings can deteriorate over time due to weather and/or continuous exposure to various traffic flows and become in need of repair.

This disclosure addresses the above-mentioned issues and more.

### SUMMARY

In one embodiment, the technology of the disclosure includes a method for determining a paint quality level for a lane marking of a road surface as a vehicle is traveling along a road having a road surface. The lane marking includes a two-dimensional object made of paint extending over at least a portion of the road surface and the paint has a paint color. The method includes receiving a sensed data stream, from an image sensor associated with the vehicle, indicating whether an obstruction exists on the road surface of the road and evaluating, using a processing unit of the vehicle, whether the road surface meets an eligibility requirement to determine a paint quality level for the road surface based on at least the sensed data stream. The eligibility requirement indicates whether the road surface is eligible to determine the paint quality level and triggers a period to capture one or more images of the road surface. The method includes capturing, using the image sensor, an image of the road surface along the road traveled by the vehicle based on whether the road surface meets the eligibility requirement; detecting, using an object detection model of the vehicle, whether the lane marking exists on the road surface within the image captured; and determining, using the processing unit of the vehicle, the paint quality level for the lane marking detected based on a paint quality degradation model and a paint color.

In some forms of the technology, the method includes determining whether a driving event is occurring in the vehicle. In some examples, the driving event indicates that the vehicle is travelling along the road. The method also includes determining whether the road surface meets the eligibility requirement when the driving event is occurring.

In one aspect of the technology, the step of evaluating whether the road surface meets the eligibility requirement includes detecting, using the image sensor, whether the obstruction exists over the road surface of the road; determining, using the processing unit, whether the paint quality level exists for the road surface; determining, using the processing unit, whether a predetermined time threshold has expired for the paint quality level for the lane marking of the road surface based on the determining that the paint quality level exists for the road surface; and determining, using the processing unit, that the road surface does not meet the eligibility requirement when at least one of the following exists: i) the obstruction exists on the road surface, ii) the paint quality level exists for the road surface, iii) the predetermined time frame associated with the paint quality level for the lane marking has not expired, or iv) a combination thereof.

In another form of the technology, the step of evaluating whether the road surface meets the eligibility requirement further includes detecting, using an image sensor, whether the obstruction exists over the road surface; determining whether the paint quality level exists for the road surface; determining whether the paint quality level exists for the road surface; determining whether a predetermined time threshold has expired for the paint quality level for the road surface based on the determining that the paint quality level; and determining that the road surface meets the eligibility requirement when at least one of the following conditions exists: i) the road surface is free of any obstruction, ii) the paint quality level for the road surface does not exist, iii) the predetermined time frame associated with the paint quality level for the road surface has expired, or iv) a combination thereof.

In a few aspects of the technology, the method includes determining, using the processing unit, a distance traveled by the vehicle on the road; determining, using the processing unit, whether the distance travelled by the vehicle exceeds a predetermined threshold; and determining, using the processing unit, a subsequent paint quality level for a subsequent lane marking of a subsequent road surface using steps a) to e) when the distance travelled exceeds the predetermined threshold.

In at least one form of the technology, the method further includes receiving location data indicating a location of the vehicle along the road; determining, using the processing unit, a lane marking location for the lane marking and the road surface of the road of the image captured based on the location data of the vehicle; storing, using the processing unit, the paint quality level associated with the lane marking, a time stamp and the lane marking location as a lane marking data in a local database in the vehicle; and transmitting the lane marking data to a remote server external to the vehicle.

In some aspects of the technology, the method further includes receiving a plurality of lane marking data. In some forms, each lane marking data is associated with a respective road surface and the lane marking data transmitted from the vehicle is at least one of the plurality of lane marking data. The method further includes generating a list of lane marking data based on the lane marking data among a plurality of lane marking data into a priority list of lane markings based on their respective paint quality level; and displaying, via a visual display, the list of lane making data.

In a few forms of the technology, the step of determining the paint quality level for the lane marking of the image includes processing a blue, green, and red color of the image into to a hue, saturation, and value color forming a color processed image; converting the color processed image having the level of hue, saturation and value into a yellow binary image using a yellow filter and a bitwise operation; and counting each nonzero yellow pixel in the yellow binary image. The yellow binary image includes nonzero white pixels and zero black pixels. The step of determining the paint quality level for the lane marking of the image further includes: determining, using the processing unit, a total number of pixels of the yellow binary image; and determining, using the processing unit, the paint quality level for the lane marking based on the total number of pixels and a number of nonzero yellow pixels.

In an aspect of the technology, the step of determining the paint quality level for the lane marking of the image further includes: converting a blue, green, and red color of the image processed into a grayscale scale color forming a grayscale image; and converting the grayscale image into a white binary image using a white filter and a bitwise operation. The white binary image includes nonzero white pixels and the zero black pixels. The step of determining the paint quality level for the lane marking of the image further includes: counting nonzero white pixels of the white binary image; counting a total number of pixels from the binary image; and determining the paint quality level for the lane marking based on the total number of pixels and the number of nonzero white pixels.

In yet another form of the technology, the step of determining the paint quality level for the lane marking of the image further includes: cropping the image to modify at least a portion of the image to adjust a size, a shape or a combination thereof of the lane marking detected in the image to form a first cropped image and a second cropped image; processing a blue, green and red color scale of the first cropped image to create contrasting pixel colors within the first cropped image using a hue, saturation, and value to form a color processed image; and converting the color processed image into a yellow binary image using a yellow filter and a bitwise operation. The yellow binary image includes nonzero yellow pixels and zero black pixels The step of determining the paint quality level for the lane marking of the image further includes: counting each nonzero yellow pixel in the yellow binary image; determining a total number of pixels of the yellow binary image; determining a yellow paint quality level for the lane marking based on the total number of pixels and a number of nonzero yellow pixels; converting a blue, green, and red color of the second cropped image to a grayscale color forming a grayscale image; and converting the grayscale image into a white binary image based on a white filter and a bitwise operation. The white binary image includes nonzero white pixels and the zero black pixels. The step of determining the paint quality level for the lane marking of the image further includes: counting nonzero white pixels of the white binary image; counting a total number of pixels from the white binary image; determining a white paint quality level for the lane marking based on the total number of pixels and the number of nonzero white pixels for the white binary image; and selecting the paint quality level as either the yellow paint quality level or the white paint quality level based on at least one of the yellow paint quality level or the white paint quality level being below a predetermined threshold.

In some aspects of the technology, the method includes receiving latitudinal and longitudinal coordinates for each data point of the lane marking; determining a location of the lane marking based on the latitudinal and longitudinal coordinates of the lane marking; determining a plurality of property details associated with the location of the lane marking. In some forms, the plurality of property details includes at least one of a road name, a city name, a state name, and a road type to form property data. The method further includes aggregating the property data with the lane marking data to form lane property data; and displaying the lane property data as mapping data on a digital map to be displayed to a user.

In another embodiment, the technology includes a vehicle system for determining a paint quality level for a lane marking of a road surface as a vehicle is travel along a road having a road surface. The lane marking includes a two-dimensional object made of paint extending over at least a portion of the road surface and the paint has a paint color. The vehicle system includes a paint quality determination module having a processing unit configured to: a) receive a sensed data stream, using an image sensor associated with the vehicle, indicating whether an obstruction exists on the road surface of the road; and b) determine, using a processing unit of the vehicle, whether the road surface meets an eligibility requirement to determine a paint quality level of the road surface. In some forms, the eligibility requirement indicates whether the road surface is eligible to determine the paint quality level and triggers a period to capture one or more images of the road surface. The processing unit is further configured to c) capture, using the image sensor, an image of the road surface along the road traveled by the vehicle based on whether the road surface is eligible to determine the paint quality level; d) detect, using an object detection model of the vehicle, whether the lane marking exists on the road surface within the image captured, using an object detection model; and e) determine, using the processing unit of the vehicle, the paint quality level for the lane marking detected based on a paint quality degradation model and a paint color.

In one form of the technology, the processing unit is further configured to: determine whether a driving event is occurring in the vehicle. In some forms, the driving event indicates that the vehicle is travelling along the road. The processing unit is further configured to: determine whether the road surface of the road meets the eligibility requirement to determine a paint quality level based on the image data when the driving event is occurring.

In some aspects of the technology, the processing unit is configured to determine whether the road surface meets the eligibility requirement to determine the paint quality level further configured to: detect, using the image sensor, whether the obstruction exists over the road surface of the road; determine whether a previously determined paint quality level exists for the lane marking of the image captured; determine whether a predetermined time threshold has expired for the previously determined paint quality level for the lane marking of the road surface based on the determining that the previously determined paint quality level exists for the lane marking associated with the road surface; and determine that the road surface does not met the eligibility requirement to determine the paint quality level for the lane marking associated with the road surface when at least one of the following exists: i) the obstruction exists over the road surface, ii) the paint quality level exists for the road surface; iii) the predetermined time threshold has not expired for a previously determined paint quality level associated with the road surface, or iv) a combination thereof.

In a few forms of the technology, the processing unit is configured to determine whether to capture the image of the road surface includes: detect whether the obstruction exists over the road surface of the road; determine whether the paint quality level exists for the road surface; determine whether a predetermined time threshold has expired for the paint quality level for the road surface based on the determining that the paint quality level exists for the road surface; and determine that the road surface meets the eligibility requirement when at least one of the following conditions exists: i) the road surface is free of any obstruction in the image data, ii) the paint quality level for the road surface does not exist, iii) the predetermined time frame associated with the paint quality level for the road surface has expired iv) or a combination thereof.

In some aspects of the technology, the processing unit is further configured to: determine a distance traveled by the vehicle on the road; determine whether the distance travelled by the vehicle exceeds a predetermined threshold; and determine a subsequent paint quality level for a subsequent lane marking of a subsequent road surface using steps a) to e) when the distance travelled exceeds the predetermined threshold.

In one form of the technology, the processing unit is configured to determine the paint quality level for the lane marking of the image captured further includes: cropping the image to modify at least a portion of the image to adjust a size, a shape or a combination thereof of the lane marking detected in the image to form a cropped image; adjusting a color scale of the cropped image cropped to create contrasting pixel colors within the image cropped forming a color scaled image; converting the color scaled image into a binary image based on a bitwise operation and a color filter; and determining the paint quality for the lane marking based on the binary image and a color filter.

In at least one aspect of the technology, the processing unit is configured to determine the paint quality level for the lane marking of the image further includes cropping the image captured to adjust a size, a shape or a combination thereof of the lane marking detected in the image to form a cropped image; processing a blue, green, and red color of the cropped image into to a hue, saturation, and value color to form a color processed image; converting the color processed image into a yellow binary image using a yellow filter and a bitwise operation; counting each nonzero yellow pixel in the yellow binary image; determining a total number of pixels of the yellow binary image; and determining the paint quality for the lane marking based on the total number of pixels and a number of nonzero yellow pixels.

In some forms of the technology, the processing unit is configured to determine the paint quality level for the lane marking of the image further includes: cropping the image captured to adjust a size, a shape or a combination thereof of the lane marking detected in the image to form a cropped image; converting a blue, green, and red color of the cropped image into a grayscale scale color forming a grayscale image; converting the grayscale image into a white binary image using a white filter and a bitwise operation; counting each nonzero white pixel of the white binary image; counting a total number of pixels from the white binary image; and determining the paint quality for the lane marking based on the total number of pixels and the number of nonzero pixels.

In yet another embodiment, the technology includes a method for determining a paint quality level for a lane marking of a road surface as a vehicle is travel along a road having a road surface. The lane marking includes a two-dimensional object made of paint extending over at least a portion of the road surface and the paint has a paint color. The method includes: a) determining whether a driving event is occurring in the vehicle, wherein the driving event indicates that the vehicle is travelling along the road; b) receiving a sensed data stream, using an image sensor associated with the vehicle, indicating whether an obstruction exists on the road surface when the driving event is occurring; c) evaluating, using a processing unit, whether the road surface meets an eligibility requirement to determine a paint quality level of the road surface based on at least the sensed data stream. The eligibility requirement indicates whether the road surface is eligible to determine the paint quality level and triggers a period to capture one or more images of the road surface. The step of evaluating whether the road surface meets the eligibility requirement to determine the paint quality level further configured to: detecting, using the image sensor, whether the obstruction exists over the road surface of the road; determining whether the paint quality level exists for the road surface; determining whether a predetermined time threshold has expired for the paint quality level for the road surface based on the determining that the paint quality level exists for the road surface; determining that the road surface meets the eligibility requirement when each of the following conditions exists: i) the road surface is free of any obstruction in the image data, ii) the paint quality level for the road surface does not exist, and iii) the predetermined time frame associated with the paint quality level for the lane marking has expired; and determining that the road surface does not meet the eligibility requirement when each of the following exists: i) the obstruction exists on the road surface, ii) the paint quality level for the road surface exists, and iii) the predetermined time frame associated with the paint quality level for the road surface has not expired. The method further includes d) capturing an image of the road surface along the road traveled by the vehicle based on whether the road surface meets the eligibility requirement; e) detecting whether the lane marking exists on the road surface within the image captured, using an object detection model, wherein the lane marking includes a paint color of a white color, a yellow color or a combination thereof; and f) determining, using the processing unit, the paint quality level for the lane marking detected based on a paint quality degradation model and the paint color, wherein the image captured includes a first image and a second image being a duplicate of the first image. The step of determining the paint quality comprises: cropping the first image to adjust a size, a shape or a combination thereof of the lane marking detected in the image to form a first cropped image; processing a blue, green, and red color of the first cropped image into to a hue, saturation, and value color to form a first color processed image; and converting the color processed image into a yellow binary image using a yellow filter and a bitwise operation. The yellow binary image includes nonzero yellow pixels and zero black pixels. The step of determining the paint quality further comprises: counting each nonzero pixel in the yellow binary image; determining a total number of pixels of the yellow binary image; determining a yellow paint quality level for the lane marking based on the total number of pixels and a number of nonzero yellow pixels; converting a blue, green, and red color of the second cropped image into a grayscale scale color forming a grayscale image; and processing the grayscale image into a white binary image using a white filter and a bitwise operation. The white binary image includes nonzero white pixels and the zero black pixels. The step of determining the paint quality further comprises: counting each nonzero white pixels of the white binary image; counting a total number of pixels from the white binary image; determining a white paint quality level for the lane marking based on the total number of pixels and the number of the nonzero white pixels; and selecting the paint quality level as either the yellow paint quality level or the white paint quality level based on at least one of the yellow paint quality level or the white paint quality level being below a predetermined threshold.

### BRIEF DESCRIPTION OF DRAWINGS

The exemplary embodiments will hereinafter be described in conjunction with the following drawing figures, wherein like numerals denote like elements, and wherein:

FIG. 1 is a diagrammatic view of an exemplary user environment for executing a method to determine a paint quality level of a lane marking on a road surface in a vehicle traveling down the road;

FIG. 2 is a flow chart summarizing the method disclosed in reference to FIG. 1;

FIG. 3 is a flow chart of a routine for determining whether the road surface is eligible to determine the paint quality level for the lane marking of the method of FIG. 2;

FIG. 4 is a flow chart of a routine for determining the paint quality level for the lane marking detected based on a paint degradation model;

FIG. 5 is a block diagram of a system operating the method disclosed in referenced of FIGS. 1 and 2; and

FIG. 6 is a block diagram of a paint quality determination module of the system illustrated in FIG. 5.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

In one form, the technology described in the disclosure includes a method and a system to determine a paint quality level of a lane marking painted on a road surface for a vehicle travelling along a road. The benefits of the described technology include an ability to scale and support prioritization of roads that may require repainting. Another benefit of this technology includes an eligibility requirement to determine when to start collecting image related data, in the vehicle, to determine a paint quality level for a lane marking. This eligibility requirement allows the vehicle to collect data only when its requirement is met. Therefore, it limits the amount of data the vehicle collects, and limits processing resources requirements for the vehicle. Still another benefit includes an on-vehicle analysis of a paint quality level that limits the bandwidth and data processing resources and cost associated with offboarding data, such as image data. Even more, the transmission of the image data is not restricted to small packet data transmission. Yet another benefit for the present technology includes a process to quantify and qualify roads for mapping and travelling in semi-autonomous and fully autonomous driving vehicles. Another benefit of this technology includes the use of multiple cameras at various locations and angles about the vehicle to capture image data. Yet another benefit includes the use of a single frame image for determining the paint quality level of a lane marking at any desired time. Still another benefit of this technology includes the use of image processing filters to provide increased accuracy when detecting and assessing the paint quality level of a lane marking.

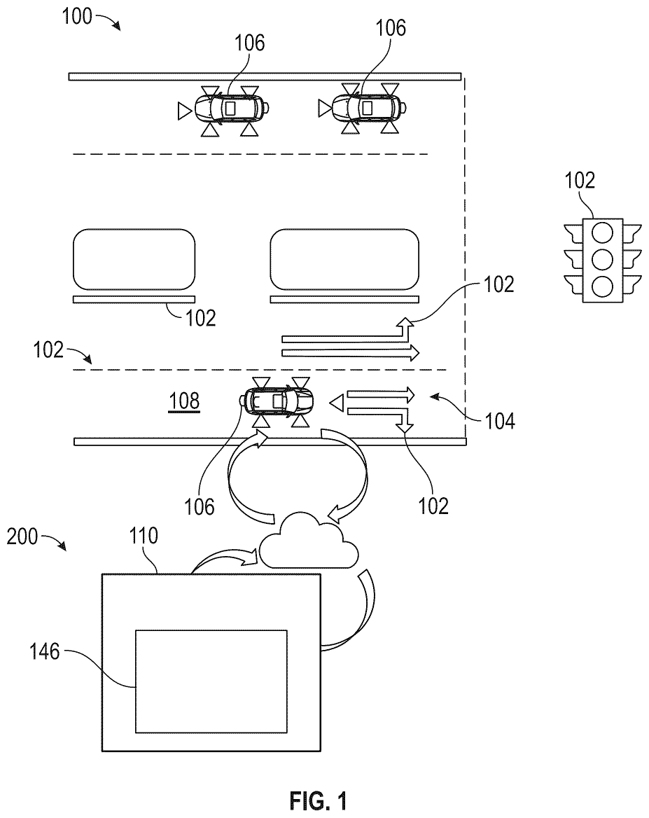

Referring to FIG. 1, an environmental view is provided of the method 100 and system 200 and method for determining a paint quality level for a lane marking (also known as road markings or pavement markings). As shown, a vehicle 106 travels along a road 108 having a road surface 104 having a plurality of lane markings 102. In one form, a lane marking 102 is applied to the road surface 104 to delineate traffic lanes and inform motorists and pedestrians of such delineated traffic lanes. In some forms, the lane markings 102 are also used to divide lanes, provide instructions to navigate vehicles from one lane to another, and direct vehicles to stop. In general, the lane marking 102 includes a two-dimensional object painted on a road surface 104 that covers at least a portion of the road surface 104 of a road 108. The lane marking 102 is typically a white color, yellow color, or a combination thereof. In some forms, the lane marking 102 may include any color of paint. For example, the lane marking 102 may resemble at least one of the following: a single solid yellow line, double solid yellow lines, a broken yellow line, a single solid white line, double solid white lines, broken white lines, end of lane markings, a right turning arrow, a left turning arrow, a multi-colored road marking for directing a vehicle towards a highway lane and the like. In one form, the system 200 includes the vehicle 106 and a remote server 110 in communication with the vehicle 106.

As shown in FIG. 1, as the vehicle 106 travels down the road 108, the system 200 captures images of a lane marking 102 on the road surface 104 of the road 108 and determines a paint quality level associated with the lane marking 102 captured in the images. The paint quality level indicates a paint characteristic that visibly displays an integrity of the lane marking 102. For example, the paint quality level indicates a paint area on the road surface 104. In other examples, the paint quality level indicates a paint volume, a paint density, a paint intensity, a color contrast, or a combination thereof. In one form, the integrity of the lane marking 102 indicates a predetermined minimum threshold for an amount of paint area for a lane marking desired for a driver to visually identify a respective lane marking. For example, the integrity of the lane marking may define that 40% of the paint area for a respective lane marking is desired as a minimal acceptable paint coverage for a driver to identify a lane marking.

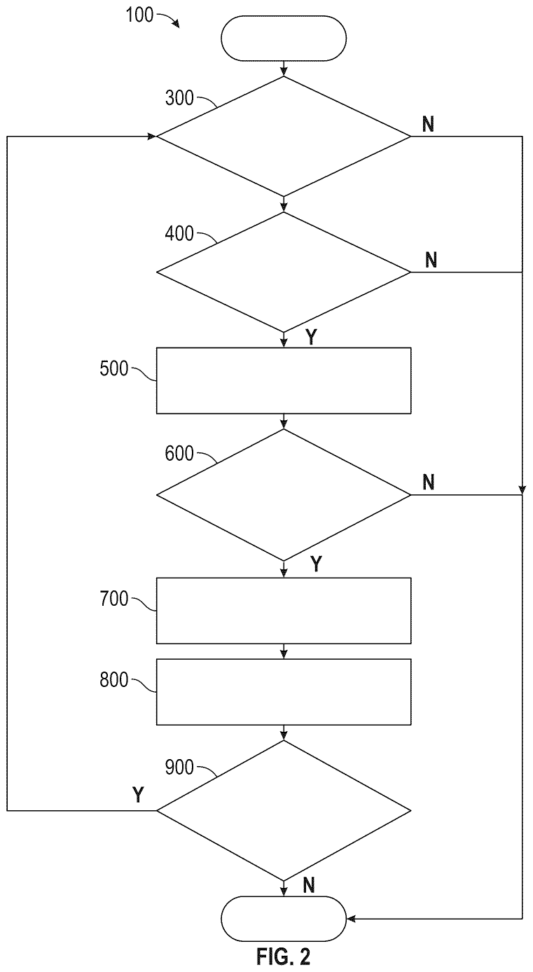

Referring to FIG. 2, the method 100 for determining a paint quality level for a lane marking 102 of a road surface 104 will now be discussed in more detail. As stated above, the method 100 is utilized and executed by the system 200. The system 200 initiates at START and proceeds to routine 300. At routine 300, the system 200 determines whether a driving event is occurring for the vehicle 106. The driving event indicates that a vehicle 106 is travelling along the road 108. In one form, the routine 300 receives sensed movement data from at least one of a plurality of sensors 112 such as a vehicle movement detection sensor 114 located in the vehicle 106. In one example, the vehicle movement detection sensor 114 may include at least one of the following sensor types: an accelerometer, a gyroscope, a global positioning system (GPS) sensor, a combination thereof or the like. The accelerometer senses acceleration of the vehicle 106, and outputs a sensed movement data in response thereof. The gyroscope senses rotational motion of the vehicle 106 and outputs a sensed movement data in response thereof. The GPS sensor detects a location of the vehicle 106 in longitudinal and latitude coordinates and processes the longitudinal and latitude coordinates and outputs a sensed movement data. The system 200 determines whether the driving event is occurring based on the sensed movement data. If the driving event is occurring, the system 200 determines “YES” and proceeds from routine 300 to routine 400. If the driving event is not occurring, the system 200 determines “NO” and proceeds to END to return to START.

At routine 400, the system 200 evaluates whether the road surface meets a predetermined eligibility requirement to determine the paint quality level for the lane marking 102. The eligibility requirement indicates whether the road surface 104 is eligible to determine the paint quality level and triggers a period to capture an image of the road surface 104. For example, the eligibility requirement includes determining that the road surface and/or the image of the road surface is free of an obstruction. The obstruction includes an object that blocks at least a portion of the road surface 104. By way of example, the obstruction includes debris or environmental elements covering over at least a portion of the road surface from being processed by the system 200. In one form of the technology, the image sensor 116 scans the road surface 104 adjacent to the vehicle 106, detects whether an obstruction exists on the road surface 104, and outputs the sensed data stream in response thereof. Based on the sensed data stream, the system 200 determines whether the road surface 104 meets the predetermined eligibility requirement. If “YES,” the system 200 proceeds from routine 400 to routine 500. If “NO,” the system 200 proceeds from routine 400 to END to return back to START.

At routine 500, the system 200 captures the image of the road surface 104, using the image sensor 116, along the road 108 traveled by the vehicle 106. For example, the image sensor 116 captures an image of the road surface 104 and outputs the image of the road surface forming an image captured. In one form, the image captured includes a single frame still image data. In another example, the image captured includes a moving image data. After capturing the image of the road surface 104, the system 200 proceeds from routine 500 to routine 600.

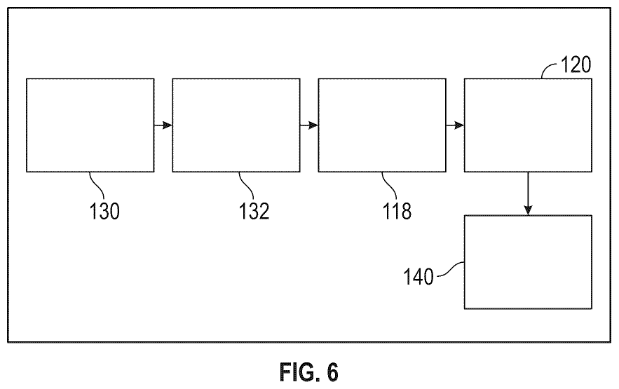

With routine 600, the system 200 determines, using an object detection model 118 (See FIG. 6), whether the lane marking 102 exists within the image captured. The object detection model 118 locates and identifies a lane marking 102 within the image captured. The object detection model 118 detects a lane marking 102 in the image captured, classifies the lane marking 102, and identifies and marks a position of the lane marking 102 in the image captured, using a bounding box to outline its location. If the lane marking 102 is detected in the image captured, the system 200 determines “YES” and proceeds from routine 600 to routine 700. If no lane marking 102 is detected in the image captured, the system 200 determines “NO” and proceeds from routine 500 to END.

At routine 700, the system 200 determines the paint quality level for the lane marking 102 detected based on a paint degradation model 120. As previously stated, the lane marking 102 has a paint color. The paint color includes a white color and/or a yellow color. In some forms, the system 200 determines the paint quality level for the lane marking 102 detected based on the paint degradation model 120 and the paint color associated with the lane marking 102 detected. After determining the paint quality, in one form, the system 200 proceeds from routine 700 to routine 800.

At routine 800, the system 200 transmits the paint quality level to a remote server 110 having a lane discoloration application 146 (See FIG. 1) to further process the paint quality level for the lane marking 102. In one form, the system 200 receives location data indicating a vehicle location as the vehicle 106 is travelling on the road surface 104. After receiving the vehicle location, the system 200 determines a lane marking location based on the vehicle location. The system 200 stores the respective paint quality level, a time stamp and the lane marking location as a lane marking data record in a paint quality database 126 in the vehicle 106 and transmits the lane marking data record to the remote server 110 external to the vehicle 106. In some forms, the system 200 may purge the lane marking data record from the paint quality database 126 after confirming that the lane marking data record was successfully transmitted to the remote server 110. After transmitting the lane marking data record, the system 200 proceeds from routine 800 to routine 900.

At routine 900, the system 200 evaluates whether to determine a subsequent paint quality level for another or a subsequent road surface 104. In one form, the system 200 evaluates a distance travelled by the vehicle 106 since determining the paint quality level for the lane marking 102. After evaluating the distance travelled by the vehicle 106, the system 200 determines whether the distance travelled by the vehicle 106 exceeds the predetermined distance threshold. For example, the predetermined distance threshold identifies how often to capture a subsequent image of the road surface 104 to determine a subsequent paint quality level. For example, the predetermined distance threshold is equal to a latitude number of 5 decimal points and a longitudinal number of 5 decimal point (e.g., 1 meter). If “YES,” the system proceeds from routine 800 to routine 300 to determine the subsequent paint quality level for the subsequent road surface 104. If “NO,” the system 200 proceeds from routine 900 to END.

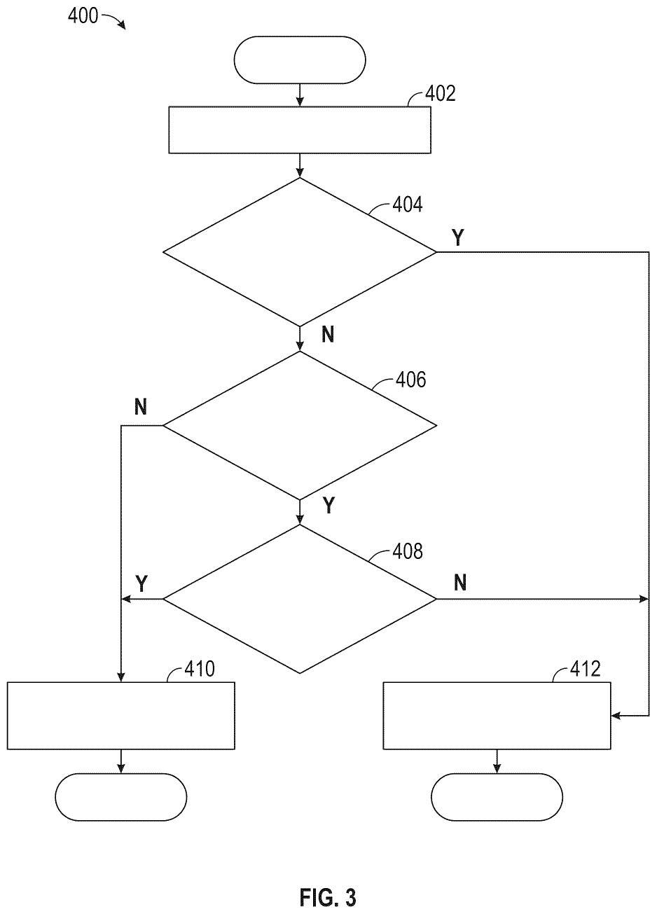

Now turning to FIG. 3, the routine 400 evaluates, using a paint quality determination module 122 (See FIGS. 5-6), whether the road surface meets the eligibility requirement to determine a paint quality level for a lane marking 102. The routine 400 begins at START and proceeds to step 402. At step 402, the routine 400 receives the sensed data stream, from the image sensor 116, indicating whether the obstruction exists on the road surface. In one form, the obstruction includes an image degradation such as a blocked image, a blurred image, an underexposed image, or the like. In another form, the obstruction includes a non-lane marking object (e.g., debris) covering the road surface 104 of the road 108. In one form, the image sensor 116 detects whether the obstruction exists on the road surface 104 based on detecting the driving event occurring and outputs the sensed data stream in response thereof. After receiving the sensed data stream, the routine 400 proceeds from step 402 to step 404.

At step 404, the routine 300 determines, using the paint quality determination module 122, detects whether the obstruction exists over the road surface 104, in real time or near real time, based on the sensed data stream. In real time or “near real time” includes any time frame of sufficiently short duration as to provided reasonable response time for on-demand information processing, such as near one (1) second or within a range of 1-2 seconds of scanning the road surface. The paint quality determination module 122 may employ image processing techniques such as edge detection, color segmentation, machine learning, or the like to determine whether the obstruction blocks at least a portion of the road surface 104. In one form, the paint quality determination module 122 detects an image degradation of the sensed data stream and outputs the obstruction data indicating that an obstruction exists in response thereof. In another form, the paint quality determination module 122 detects a change in a quality of the sensed data stream and outputs the obstruction data indicating that the obstruction exists in response thereof. In one form, the change in the sensed data stream includes a change in light intensity, at least a portion of the image being a blurry area, or the like. In yet another form, the paint quality determination module 122 detects when an object exists in the sensed data stream that is not a lane marking 102 or a road surface 104 and outputs the obstruction data indicating that the obstruction exists in response thereof. Based on the obstruction data, the routine 400 determines whether the obstruction exists on the road surface. If the obstruction exists, the routine 400 determines “YES” and proceeds to from step 404 to step 412. On the other hand, if the obstruction does not exist, the routine 400 determines “NO” and proceeds from step 404 to step 406.

The routine 400 determines whether a previously determined paint quality level exists for a location associated with a lane marking on the road surface 104 of the road 108 at step 406. In one form, the routine 400 searches a paint quality database 126 (See FIG. 5) to determine whether the previously determined paint quality level exists for the location association with the lane marking 102. In one form, the paint quality database 126 is located in the vehicle 106. In another example, the paint quality database 126 may be located on the remote server 110. If “YES,” the routine 400 proceeds from step 406 to step 408. If “NO,” the routine proceeds from step 406 to step 410.

At step 408, the routine 400 determines whether a predetermined time threshold has expired since the previously determined paint quality level was determined. In one form, the predetermined time threshold is defined by a period of time that has elapsed since determining the paint quality level for the lane marking 102. The predetermined time threshold may be determined based on a rate of decay for lane marking quality, such as a paint type, paint brand, road age, road surface type, season, weather factors (temperature, precipitation, UV exposure), etc. In this example, the predetermined time threshold is set to a 2-week time period. If “YES,” the routine 400 proceeds from step 408 to step 410. If “NO,” the routine 400 proceeds from step 408 to 412.

At step 410, the routine 400 determines that the road surface 104 meets the eligibility requirement to determine the paint quality level for the road surface 104. For example, the eligibility requirement is met when at least one or more of the following conditions exists: i) the road surface 104 is free of any obstruction in the image data, ii) the previously determined paint quality level for the lane marking 102 of the road surface 104 does not exist, and iii) the predetermined time frame associated with an existing predetermined paint quality level for the lane marking 102 has expired. The routine 400 proceeds from step 410 to routine 500.

At step 412, the routine 400 determines that the road surface 104 does not meet the eligibility requirement to determine the paint quality level for the road surface 104. For example, the eligibility requirement has not been met when at least one or more of the following exists: i) the obstruction exists over the road surface 104, ii) the paint quality level exists for the road surface; iii) the predetermined time threshold has not expired for a previously determined paint quality level associated with the road surface 104, or iv) a combination thereof. The routine 400 proceeds from step 412 to END.

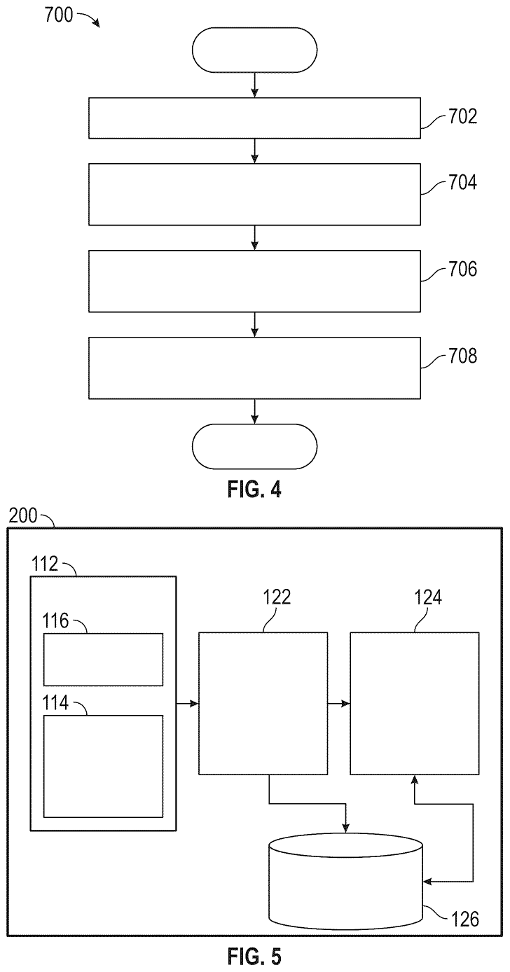

Turning to FIG. 4, the routine 700 determines, using the paint quality determination module 122, the paint quality level for the lane marking 102 detected based on a paint degradation model 120 (See FIG. 6). In one form, the routine 700 begins at START and proceeds to step 702. At step 702, the routine 700 crops, using the paint degradation model 120, the image captured to modify a size, a shape, or a combination thereof of the lane marking 102 detected in the image captured into a cropped image having the lane marking 102. In one example, the routine 700 uses dimensions associated with the bounding box to crop the image captured to form a cropped image. The cropped image is then duplicated forming a first cropped image and a second cropped image. In one form, the first cropped image and the second cropped image are identical in size and shape and include the lane marking 102 detected. After forming the first cropped image and the second cropped image, the routine 700 proceeds from step 702 to step 704.

The routine 700 adjusts, using the paint degradation model 120, a color scale of the cropped image to create contrasting pixel colors within the cropped image forming a color processed image at step 704. The lane marking 102 generally includes a paint color of white, yellow or a combination thereof. In one form, the routine 700 processes the lane marking 102 of the first cropped image as having a yellow paint color. The routine 700 also processes the lane marking 102 of the second cropped image as having a white paint color. In one form, the routine 700 simultaneously processes each of the first cropped image and the second cropped image at the same time. In other forms, the routine 700 processes the first cropped image and the second cropped image sequentially. In another aspect, the routine 700 processes a red-green-blue (RGB) color scale of the first cropped image to create a first plurality of contrasting pixels having a hue, saturation value (HSV) color forming a first color processed image. In an analogous manner, the routine 700 processes the RGB color scale of the second cropped image to create a second plurality of contrasting pixels having a grayscale color scale forming a second color processed image. After processing each of the first color processed image and the second color processed image, the routine 700 proceeds from step 704 to step 706.

At step 706, the routine 700 converts, using the paint degradation model 120, the color processed image into a binary image based on a predetermined color filter and a bitwise operation. In general, the bitwise operator performs operations to manipulate individual bits of data, such as zeros and ones. In particular, the routine 700 converts the first color processed image into a yellow binary image using a yellow filter mask and the bitwise operation. The yellow binary image includes nonzero yellow pixels and zero black pixels. For example, the routine 700 applies a yellow filter with a lower bound=[15, 80,80] and an upper bound=[35, 255, 255] to create the yellow filter mask. For each pixel in the first color processed image, the routine 700 applies the bitwise operation and the yellow filter mask and thereby creates the yellow binary image. In a like manner, the routine 700 converts the second color processed image into a white binary image based on a white filter mask and the bitwise operation. The second color processed image is a grayscale image that is processed as having black and white pixels. For example, if a pixel in the second color processed image has an intensity between 0 to 200, the routine 700 processes the pixel as being a black pixel and is set to a default of zero (0) intensity. On the other hand, if the pixel has intensity between 201 and 255, the routine 700 processes the pixel as being a white pixel and is set to a default of 255 intensity. In one form, the white filter mask includes an intensity filter threshold between 200 and 255. For each pixel in the second color processed image, the routine 700 applies the bitwise operation and the white filter mask and thereby creates a white binary image. The white binary image includes nonzero white pixels and the zero black pixels. In one example, each pixel is defined by a number to equate the pixel as being either black or white based on the number of its respective intensity. After creating the yellow binary image and the white binary image, the routine 700 proceeds from step 706 to step 708.

The routine 700 determines, using the paint degradation model 120, the paint quality level for the lane marking 102 associated with the binary image at step 708. In one form, the routine 700 counts each nonzero yellow pixel in the yellow binary image, determines a total number of pixels in the binary image, and computes a yellow paint quality level based on the total number of pixels and the number of nonzero yellow pixels. The yellow paint quality level includes a value, a percentage or a ratio of the number of nonzero yellow pixels to the total number of pixels of the yellow binary image. In another form, the routine 700 counts nonzero pixels of the white binary image, counts a total number of pixels from the white binary image, and generates a white paint quality level based on the total number of pixels and the number of nonzero white pixels for the white binary image. Similar to the yellow paint quality level, the white paint quality level is a value between 0 and 1 equal to a percentage or ratio of the number of nonzero pixels to the total number of pixels of the white binary image. In one form, the higher the value, the percentage, the ratio, the higher an amount of yellow or white paint color exists for the lane marking 102. In contrast, the lower the value, the percentage, the ratio the lower the amount of the yellow or white paint color exists for the lane marking 102. In one form, the routine 700 selects at least one of the yellow paint quality level and the white paint quality level for the lane marking detected. For example, the routine 700 selects the yellow paint quality level if the yellow paint quality level is above a predetermined threshold and the white paint quality level within a range of the predetermined white threshold. In one example, the predetermined threshold is substantially equal to zero (0). The routine 700 selects the white paint quality level when the white paint quality level is above the predetermined threshold and the yellow paint quality level is within a range of the predetermined threshold. The routine 700 may discard the yellow paint quality level and the white paint quality level when each paint quality level is within a range of the predetermined threshold. After determining the paint quality level, the routine 700 proceeds from step 708 to routine 800.

Now referring to FIG. 5, the system 200 is further illustrated for implementing the method 100 having routines 300-900. In one form, the system 200 includes the plurality of sensors 112, the paint quality determination module 122, a communication module 124, and a paint quality database 126. The sensors 112 include the vehicle movement detection (VMD) sensors 114 and the image sensors 116. The VMD sensors 114 detect a movement and location of the vehicle 106 along the road surface 104 and outputs movement data in response thereof. In one example, the VMD sensors 114 include an onboard sensor such as an accelerometer, a gyroscope, the GPS sensor, a combination thereof or the like. The accelerometer senses acceleration of the vehicle 106, and outputs a sensed movement data in response thereof. The gyroscope senses rotational motion of the vehicle and outputs a sensed motion data stream in response thereof. The GPS sensor detects a location of the vehicle in longitudinal and latitude coordinates.

In one example, the image sensor 116 is located about of the vehicle 106. For example, the image sensor 116 includes at least one of a digital camera, a camera module, a thermal imaging devices, a radar, a sonar, a combination thereof or the like. For illustration purposes, the image sensor 116 is a camera module that scans the road surface 104, detects whether an obstruction exists on the road surface and outputs the sensed data stream in response thereof. In one form, the sensed data stream includes moving image data.

In another example, the image sensor 116 captures a single frame image of a road surface 104 and outputs the image captured of the road surface 104. In one form, the single frame image includes a still image. In some examples, the image sensor 116 includes a plurality of image sensors arranged at various locations about the vehicle 106 to provide multiple angles to view the road surface 104 for determining the paint quality level for a single lane marking 102 or multiple lane markings 102. For example, the plurality of image sensors includes a front image sensor, a rear image sensor, an undercarriage image sensor, a left image sensor and a right image sensor with respect to the vehicle. The front image sensor is located about a front of the vehicle 106. The front image sensor captures an image of a road surface 104 located in a front location of the vehicle 106, and outputs a front image data in response thereof. The rear image sensor is located about the rear side of the vehicle 106. The rear camera sensor captures an image of the road surface 104 located in a back location of the vehicle 106 and outputs a rear image data in response thereof. The undercarriage camera sensor is located on or near an undercarriage side of the vehicle 106. The under-carriage camera sensor captures an image of a road surface 104 located under the vehicle 106 and outputs an undercarriage image data in response thereof. The left side camera sensor is located on or about the left side of the vehicle 106. The left side camera sensor captures an image of the road surface 104 located on the left side of the vehicle 106 and outputs a left side image data in response thereof. The right-side camera sensor is located on the right side of the vehicle. The right-side camera sensor captures an image of the road surface 104 located on the right side of the vehicle 106 and outputs a right-side image data in response thereof. While each of the plurality of image sensors may individually capture images of one or more road surfaces 104 and output one or more images in response thereof, each of the front image sensor, the rear image sensor, the undercarriage image sensor, the right side image sensor, the left side image sensor have similar features and functions and shall be individually and collectively referred to as “the image sensor 116.”

With reference now to FIGS. 5 and 6, the paint quality determination module 122 is in communication with the plurality of sensors 112 and receive the movement data, the sensed data stream, the image captured of the road surface 104 or a combination thereof. The paint quality determination module 122 includes a driving event detector 130, an eligibility determinator 132, the object detection model 118, the paint degradation model 120, and a distance detector 140.

The driving event detector 130 executes routine 300 and determines whether a driving event is occurring. The driving event indicates that the vehicle 106 is travelling along the road 108. The driving event detector 130 is in communication with the sensors 112. The driving event detector 130 receives the movement data from the VMD sensor 114 and determines whether the driving event is occurring based on the movement data.

The eligibility determinator 132 is in communication with the driving event detector 130 and the image sensor 116. The eligibility determinator 132 executes routine 400 and evaluates whether the road surface 104 meets an eligibility requirement to determine a paint quality level for the lane marking 102 associated with the road surface 104 based on at least the sensed data stream. The eligibility requirement indicates whether the road surface 104 is eligible to determine the paint quality level and triggers a period to capture one or more images of the road surface 104.

The object detection model 118 is in communication with the eligibility determinator 132 and the image sensor 116. The object detection model 118 executes routine 600 and determines whether the lane marking 102 exists within the image captured. The object detection model 118 receives the image captured from the image sensor 116. In addition, the object detection model 118 locates and identifies a lane marking 102 within each image captured, detects a lane marking 102 in the image captured, classifies the lane marking 102, and identifies and marks a position of the lane marking 102 in the image. For example purposes, the object detection model 118 includes a machine learning model to classify and determine a location and position of the lane marking 102 in the image captured. In one example, the machine learning model includes at least one of a plurality of model architectures such as one or more supervised learning model, one or more unsupervised learning model, and one or more neural network models (e.g., deep neural network (DNN), convolution neural network (CNN), spiking neural network (SNN)).

The paint degradation model 120 is in communication with the object detection model 118. The paint degradation model 120 executes routine 700 and determines the paint quality level for the lane marking 102 detected in the image captured. In one form, the paint degradation model 120 employs one or more image processing techniques such as an image editing process. For example purposes, the image editing process includes at least one of a raster graphics editor or a vector graphics editor. As previously stated, lane marking 102 has a paint color of a white color and/or a yellow color. The paint degradation model 120 determines the paint quality level for the lane marking 102 detected based on the paint color associated with the lane marking 102 detected.

In one form, the paint degradation model 120 receives location data indicating a vehicle location as the vehicle is travelling on the road surface 104. After receiving the vehicle location, the paint degradation model 120 determines a lane marking location based on the vehicle location. The paint degradation model 120 stores the paint quality level associated with the lane marking 102 detected, a time stamp and the lane marking location as a lane marking data in the paint quality database in the vehicle 106.

The paint degradation model 120 receives GPS coordinates for each data point of the lane marking 102. The paint degradation model 120 aligns the GPS coordinates with each data point of the lane marking 102 in the lane marking data. The paint degradation model 120 determines a plurality of property details associated with the location of the lane marking 102. The plurality of property details includes at least one of a road name, a city name, a state name, and a road type to form property data. The paint degradation model 120 aggregates the property data with the lane marking data to form lane property data and stores the lane property data in the paint quality database 126.

The distance detector 140 is in communication with the paint degradation model 120. The distance detector 140 executes routine 900 and determines whether to determine a subsequent paint level quality for a subsequent lane marking 102 associated with a subsequent road surface 104. The distance detector 140 determines a distance travelled by the vehicle 106 since determining the paint quality level for the lane marking 102. After determining the distance travelled by the vehicle 106, the distance detector 140 determines whether the distance travelled by the vehicle 106 exceeds the predetermined distance threshold. In one example, the predetermined distance threshold identifies the frequency at which to capture an image of the road surface 104 for purposes of determining the paint quality level of the lane marking 102. For example, the predetermined distance threshold is equal to a latitude number of five (5) decimal points and a longitudinal number of five (5) decimal point (e.g., 1 meter).

The communication module 124 is in communication with the paint degradation model 120 and the remote server 110. The communication module 124 receives the lane marking data and related data from the paint quality database 126 and transmits the paint quality level along with the lane marking data to the remote server 110. In one form, the remote server includes a cloud-based application 146, such as a lane discoloration application 146 to further process the paint quality level for the lane marking 102. In some forms, the lane discoloration application 146 generates a list of lane markings based on one or more priority factors and displays the list of lane markings to a user for review. In one form, the communication module 124 purges the lane marking data from the paint quality database after transmitting the lane marking data.

Referring again to FIG. 1, the remote server 110 hosts a cloud-based application 146 for displaying a list of lane markings, such as the lane discoloration application 146 (see FIG. 1). In one form, the cloud-based application 146 receives lane marking data associated with respective road surfaces 104 and the lane marking data transmitted from the vehicle. The cloud-based application 146 generates a list of lane markings listed in order of priority based on the plurality of lane marking data. The cloud-based application 146 includes a visual display for displaying the priority list of lane makings. The cloud-based application 146 may provide a graphical image of the list of lane markings along with their respective paint quality levels in real time. The cloud-based application 146 may also display a priority list of lane markings based on the paint quality levels having a lowest values. The cloud-based application 146 may further display a priority list of lane markings based on their respective decay value.

The cloud-based application 146 may also plot the lane marking data on a digital graph to display a historical trend data. The cloud-based application 146 estimates a length of time of decay for the lane marking 102 associated with the lane marking data by comparing the paint quality level of the lane marking 102 to other historical data trends. The cloud-based application 146 determines whether supplemental data exists to further estimate when the paint quality level for the lane marking 102 will reach a lower threshold having an unacceptable value. The supplemental data includes traffic volume, road decay data, road health data, road paint specifications, and a road paint application date. The cloud-based application 146 receives at least one of the traffic volume, the road decay data, the road health data, the road paint specifications, and the road paint application date and computes the estimated time when the paint quality level will reach a lower threshold for the lane marking 102. The cloud-based application 146 may then display the estimated time, via the visual display, to a user.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method for determining a paint quality level for a lane marking on a road surface of a road with a vehicle traveling along the road, wherein the lane marking comprises a painted object disposed on at least a portion of the road surface, the method comprising:
a) receiving a sensed data stream, from an image sensor associated with the vehicle, indicating whether an obstruction exists on the road surface of the road;
b) evaluating, using a processing unit of the vehicle, whether the road surface meets an eligibility requirement to determine a paint quality level for the road surface based on at least the sensed data stream, wherein the eligibility requirement indicates whether the road surface is eligible to determine the paint quality level and triggers a period to capture one or more images of the road surface;
c) capturing, using the image sensor, an image of the road surface along the road traveled by the vehicle based on whether the road surface meets the eligibility requirement;
d) detecting, using an object detection model of the vehicle, whether the lane marking exists on the road surface within the image captured; and
e) determining, using the processing unit of the vehicle, the paint quality level for the lane marking detected based on a paint quality degradation model and a paint color of the lane marking.

2. The method of claim 1 further comprising:
determining whether a driving event is occurring in the vehicle, wherein the driving event indicates that the vehicle is travelling along the road; and
determining whether the road surface of the road meets the eligibility requirement when the driving event is occurring.

3. The method of claim 1, wherein the step of evaluating whether the sensed data stream meets the eligibility requirement to determine the paint quality level further comprises:
detecting, using an image sensor, whether an obstruction exists over the road surface of the road;
determining, using the processing unit, whether the paint quality level exists above a threshold value for road surface;
determining, using the processing unit, whether a predetermined time threshold has expired for the paint quality level for the road surface based on the determining that the paint quality level exists for the road surface; and
determining, using the processing unit, that the road surface is not eligible to determine the paint quality level for the lane marking associated with the road surface when at least one of the following exists: i) the obstruction exists on the road surface, ii) the paint quality level for the lane marking exists for the road surface, iii) the predetermined time frame associated with the paint quality level for the road surface has not expired, or iv) a combination thereof.

4. The method of claim 1, wherein the step of evaluating whether the sensed data stream meets the eligibility requirement to determine the paint quality level further comprises:
detecting, using an image sensor, whether an obstruction exists over the road surface;
determining whether the paint quality level exists for the road surface;
determining whether a predetermined time threshold has expired for the paint quality level for the road surface based on the determining that the paint quality level exists for the road surface; and
determining that the road surface meets the eligibility requirement when at least one of the following conditions exists: i) the road surface is free of any obstruction in the image data, ii) the paint quality level for the road surface does not exist, iii) the predetermined time frame associated with the paint quality level for the road surface has expired, or iv) a combination thereof.

5. The method of claim 1 further comprising:
determining, using the processing unit, a distance traveled by the vehicle on the road;
determining, using the processing unit, whether the distance travelled by the vehicle exceeds a predetermined threshold; and
determining, using the processing unit, a subsequent paint quality level for a subsequent lane marking of a subsequent road surface using steps a) to e) when the distance travelled exceeds the predetermined threshold.

6. The method of claim 1 further comprises:
receiving location data indicating a location of the vehicle along the road;
determining, using the processing unit, a lane marking location for the lane marking and the road surface of the road of the image captured based on the location data of the vehicle;
storing, using the processing unit, the paint quality level associated with the lane marking, a time stamp and the lane marking location as a lane marking data in a local database in the vehicle; and
transmitting the lane marking data to a remote server external to the vehicle.

7. The method of claim 6 further comprising:
receiving a plurality of lane marking data, wherein each lane marking data is associated with a respective road surface and the lane marking data transmitted from the vehicle is at least one of the plurality of lane marking data;
generating a list of lane marking data based on the lane marking data among a plurality of lane marking data into a priority list of lane markings based on their respective paint quality level; and
displaying, via a visual display, the list of lane making data.

8. The method of claim 1, wherein the step of determining the paint quality level for the lane marking of the image further comprises:
processing a blue, green, and red color of the image into to a hue, saturation, and value color forming a color processed image;
converting the color processed image having the level of hue, saturation and value into a yellow binary image using a yellow filter and a bitwise operation, wherein the yellow binary image includes nonzero yellow pixels and zero black pixels;
counting each nonzero yellow pixel in the yellow binary image;
determining, using the processing unit, a total number of pixels of the yellow binary image; and
determining, using the processing unit, the paint quality level for the lane marking based on the total number of pixels and a number of nonzero yellow pixels.

9. The method of claim 1, wherein the step of determining the paint quality level for the lane marking of the image further comprises:
converting a blue, green, and red color of the image processed into a grayscale scale color forming a grayscale image;
converting the grayscale image into a white binary image using a white filter and a bitwise operation, wherein the white binary image includes nonzero white pixels and the zero black pixels;
counting nonzero white pixels of the white binary image;
counting a total number of pixels from the white binary image; and
determining the paint quality level for the lane marking based on the total number of pixels and the number of nonzero white pixels.

10. The method of claim 1 wherein the step of determining the paint quality level for the lane marking of the image further comprises:
cropping the image to modify at least a portion of the image to adjust a size, a shape, or a combination thereof of the lane marking detected in the image to form a first cropped image and a second cropped image;
processing a blue, green, and red color scale of the first cropped image to create contrasting pixel colors within the first cropped image using a hue, saturation, and value to form a color processed image having yellow and black pixels;
converting the color processed image into a yellow binary image using a yellow filter and a bitwise operation, wherein the yellow binary image includes nonzero yellow pixels and zero black pixels;
counting each nonzero yellow pixel in the yellow binary image;
determining a total number of pixels of the yellow binary image;
determining a yellow paint discoloration indicator based on the total number of pixels and a number of nonzero yellow pixels;
converting a blue, green, and red color of the second cropped image to a grayscale scale color forming a white image;
converting the white image into a white binary image based on a white filter and a bitwise operation, wherein the white binary image includes nonzero white pixels and the zero black pixels;
counting nonzero pixels of the white binary image;
counting a total number of pixels from the white binary image;
generating a white paint discoloration indicator of the paint of the lane marking based on the total number of pixels and the number of nonzero pixels for the white binary image; and
selecting the paint quality level as either the white paint quality level or the yellow paint quality level based on at least one of the white paint quality level or the yellow paint quality level below a predetermined threshold.

11. The method of claim 1 further comprising:
receiving latitudinal and longitudinal coordinates for each data point of the lane marking;
determining a location of the lane marking based on the latitudinal and longitudinal coordinates of the lane marking;
determining a plurality of property details associated with the location of the lane marking, wherein the plurality of property details include at least one of a road name, a city name, a state name, and a road type to form property data;
aggregating the property data with the lane marking data to form lane property data; and
displaying the lane property data as mapping data on a digital map to be displayed to a user.

12. A vehicle system for determining a paint quality level for a lane marking of a road surface of a road as a vehicle is traveling along the road, wherein the lane marking comprises a painted object disposed on at least a portion of the road surface, the vehicle system comprising:
a paint quality determination module having a processing unit configured to:
a) receive a sensed data stream, from an image sensor associated with the vehicle, indicating whether an obstruction exists over the road surface of the road;
b) determine, using a processing unit of the vehicle, whether the road surface meets an eligibility requirement to determine a paint quality level of the road surface based on the sensed data stream, wherein the eligibility requirement indicates whether the road surface is eligible to determine the paint quality level and triggers a period to capture one or more images of the road surface;
c) capture, using the image sensor, an image of the road surface along the road traveled by the vehicle based on whether the road surface meets the eligibility requirement;
d) detect, using an object detection model of the vehicle, whether the lane marking exists on the road surface within the image captured; and
e) determine, using the processing unit of the vehicle, the paint quality level for the lane marking detected based on a paint quality degradation model and a paint color of the lane marking.

13. The vehicle system of claim 12 wherein the processing unit is further configured to:
determine whether a driving event is occurring in the vehicle, wherein the driving event indicates that the vehicle is travelling along the road; and
determine whether the road surface of the road meets the eligibility requirement based on when the driving event is occurring.

14. The vehicle system of claim 12, wherein the processing unit is configured to determine whether the road surface meets the eligibility requirement to determine the paint quality level further comprises:
detect, using the image sensor, whether the obstruction exists over the road surface;
determine whether the paint quality level exists for the road surface;
determine whether a predetermined time threshold has expired for the paint quality level for the road surface based on the determining that the paint quality level exists; and
determine that the road surface does not meet the eligibility requirement when at least one of the following exists: i) the obstruction exists on the road surface, ii) the paint quality level for the road surface exists, iii) the predetermined time frame associated with the paint quality level for the road surface has not expired, or iv) a combination thereof.

15. The vehicle system of claim 12, wherein the processing unit is configured to determine whether the road surface meets the eligibility requirement to determine the paint quality level further comprises:
detect, using an image sensor, whether the obstruction exists over the road surface of the road;
determine, using a processing unit, whether the paint quality level exists for the road surface;
determine, using a processing unit, whether a predetermined time threshold has expired for the paint quality level for the road surface based on the step of determining whether the paint quality level exists; and
determine, using a processing unit, that the road surface meets the eligibly requirement when at least one of the following conditions exists: i) the obstruction exists over the road surface, ii) the paint quality level for the road surface does not exist, and the predetermined time frame associated with the paint quality level for the road surface has expired, and iii) a combination thereof.

16. The vehicle system of claim 12, wherein the processing unit is further configured to:
determine a distance traveled by the vehicle on the road;
determine whether the distance travelled by the vehicle exceeds a predetermined threshold; and
determine a subsequent paint quality level for a subsequent lane marking of a subsequent road surface using steps a) to e) when the distance travelled exceeds the predetermined threshold.

17. The vehicle system of claim 12, wherein the processing unit is configured to determine the paint quality level for the lane marking of the image captured further comprises:
crop the image to modify at least a portion of the image to adjust a size, a shape, or a combination thereof of the lane marking detected in the image to form a cropped image;
adjust a color scale of the cropped image cropped to create contrasting pixel colors within the image cropped forming a color scaled image;
convert the color scaled image into a binary image based on a bitwise operation and a color filter; and
determine the paint quality for the lane marking based on the binary image and a color filter.

18. The vehicle system of claim 12, wherein the processing unit is configured to determine the paint quality level for the lane marking of the image further comprises:
crop the image captured to adjust a size, a shape, or a combination thereof of the lane marking detected in the image to form a cropped image;
process a blue, green, and red color of the cropped image into to a hue, saturation, and value color to form a color processed image;
convert the color processed image into a yellow binary image using a yellow filter and a bitwise operation, wherein the yellow binary image includes nonzero yellow pixels and zero black pixels;
count each nonzero pixel in the yellow binary image;
determine a total number of pixels of the yellow binary image; and
determine the paint quality level for the lane marking based on the total number of pixels and a number of nonzero pixels.

19. The vehicle system of claim 12, wherein the processing unit is configured to determine the paint quality level for the lane marking of the image further comprises:
crop the image captured to adjust a size, a shape, or a combination thereof of the lane marking detected in the image to form a cropped image;
convert a blue, green, and red color of the cropped image into a grayscale scale color forming a grayscale image;
convert the grayscale image into a binary image using a white filter and a bitwise operation;
count nonzero pixels of the white binary image, wherein the white binary image includes nonzero white pixels and zero black pixels;
count a total number of pixels from the white binary image; and
determine the paint quality level for the lane marking based on the total number of pixels and the number of nonzero white pixels.

20. A method for determining a paint quality level for a lane marking on a road surface of a road with a vehicle traveling along the road, wherein the lane marking includes a painted object disposed on at least a portion of the road surface, the method comprising:
a) determining whether a driving event is occurring in the vehicle, wherein the driving event indicates that the vehicle is travelling along the road;
b) receiving a sensed data stream, using an image sensor associated with the vehicle, indicating whether an obstruction exists on the road surface when the driving event is occurring;
c) evaluating, using a processing unit, whether the road surface meets an eligibility requirement to determine a paint quality level of the road surface based on at least the sensed data stream, wherein the eligibility requirement indicates whether the road surface is eligible to determine the paint quality level and triggers a period to capture one or more images of the road surface, wherein the step of evaluating whether the road surface meets the eligibility requirement to determine the paint quality level includes:
detecting, using the image sensor, whether an obstruction exists over the road surface;
determining whether the paint quality level exists for the road surface;
determining whether a predetermined time threshold has expired for the paint quality level for the road surface based on the determining that the paint quality level exists for the road surface; and
determining that the road surface meets the eligibility requirement when each of the following conditions exists: i) the road surface is free of any obstruction in the image data, ii) the paint quality level for the road surface does not exist, and iii) the predetermined time frame associated with the paint quality level for the lane marking has expired;
d) capturing an image of the road surface along the road traveled by the vehicle when the road surface meets the eligibility requirement;
e) detecting whether the lane marking exists on the road surface within the image captured, using an object detection model, wherein the lane marking includes a paint color selected from the group consisting of a white color, a yellow color, or a combination thereof; and
f) determining, using the processing unit, the paint quality level for the lane marking detected based on a paint quality degradation model and the paint color, wherein the image captured includes a first image and a second image being a duplicate of the first image, and wherein the determining the paint quality comprises:
cropping the first image to adjust a size, a shape, or a combination thereof of the lane marking detected in the image to form a first cropped image;
processing a blue, green, and red color of the first cropped image into to a hue, saturation, and value color to form a color processed image;
converting the color processed image into a yellow binary image using a yellow filter and a bitwise operation, wherein the yellow binary image includes nonzero yellow pixels and zero black pixels;
counting each nonzero pixel in the yellow binary image;
determining a total number of pixels of the yellow binary image; and
determining a yellow paint quality level for the lane marking based on the total number of pixels and a number of nonzero yellow pixels;
converting a blue, green, and red color of the second cropped image into a grayscale scale color forming a grayscale image;
processing the grayscale image into a white binary image using a white filter and a bitwise operation, wherein the white binary image includes nonzero white pixels and the zero black pixels;
counting each nonzero white pixel of the white binary image;
counting a total number of pixels from the white binary image;
determining a white paint quality level for the lane marking based on the total number of pixels and a number of nonzero white pixels; and
selecting the paint quality level as either the yellow paint quality level or the white paint quality level based on at least one of the yellow paint quality level or the white paint quality level being below a predetermined threshold.
